(19) United States
(12) Patent Application Publication
(10) Pub. No.: US 2022/0188623 A1
(43) Pub. Date: Jun. 16, 2022

(54) EXPLAINABLE DEEP REINFORCEMENT LEARNING USING A FACTORIZED FUNCTION

(71) Applicant: Palo Alto Research Center Incorporated, Palo Alto, CA (US)

(72) Inventor: Robert Price, Palo Alto, CA (US)

(21) Appl. No.: 17/118,165

(22) Filed: Dec. 10, 2020

(51) Int. Cl. G06N 3/08

(52) U.S. Cl. CPC G06N 3/08

(57) ABSTRACT

A policy based on a compound reward function is learned through a reinforcement learning algorithm at a learning network. The policy is used to choose an action of a plurality of possible actions. A state-action value network is established for each of the two or more reward terms. The state-action value networks are separated from the learning network. A human-understandable output is produced to explain why the action was taken based on each of the state action value networks.

### TECHNICAL FIELD

The present disclosure is directed to implementing deep learning in real-world applications.

### SUMMARY

Embodiments described herein involve a method for providing human understandable explanations for an action in a machine reinforcement learning framework. A policy based on a compound reward function is learned through a reinforcement learning algorithm at a learning network. The policy is used to choose an action of a plurality of possible actions. A state-action value network is established for each of the two or more reward terms. The state-action value networks are separated from the learning network. A human-understandable output is produced to explain why the action was taken based on each of the state action value networks.

Embodiments described herein involve a system comprising a processor and a memory storing computer program instructions which when executed by the processor cause the processor to perform operations. The operations comprise learning, through a reinforcement learning algorithm at a learning network, a policy based on a compound reward function, the compound reward function comprising a sum of two or more reward terms. The policy is used to choose an action of a plurality of possible actions. A state-action value network is established for each of the two or more reward terms. According to various embodiments, the state-action value networks are separated from the learning network. A human-understandable output is produced to explain why the action was taken based on each of the state action value networks.

The above summary is not intended to describe each embodiment or every implementation. A more complete understanding will become apparent and appreciated by referring to the following detailed description and claims in conjunction with the accompanying drawings.

### BRIEF DESCRIPTION OF THE DRAWINGS

FIG. 1 shows a way to obtain human-understandable outputs for why an action was taken in accordance with embodiments described herein;

FIG. 2 illustrates a process for determining why an action was taken in accordance with embodiments described herein;

FIG. 3 shows a way to obtain human-understandable outputs for why an action was taken using a factorized state-action function in accordance with embodiments described herein;

FIG. 4 illustrates actions plotted in a tradeoff space in accordance with embodiments described herein;

FIG. 5 shows a way to obtain human-understandable outputs for why an action was taken in which the explanation network does not share a representation with the underlying policy learner in accordance with embodiments described herein; and

FIG. 6 shows a block diagram of a system capable of implementing embodiments described herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments described herein involve a way of using reward factorization in an auxiliary network to get explanations of deep learning-based reinforcement learners without compromising convergence of the network. These explanations help to explain why the agent did what it did. Embodiments described herein can be combined with state-of-the-art innovations in policy gradient learning (e.g., AC3) to get efficient, powerful learners that work with unstructured state and action spaces.

Embodiments described herein involve contexts where deep learning has been applied to high-dimensional visual inputs to solve tasks without encoding any task specific features. For instance, the deep Q-learning network (DQN)) can be trained on screen images of the Atari Pong game to learn how to move the paddles to score well in the game. The network learns to visually recognize and attend to the ball in screen images in order to play. The same network can be trained on screen images of Atari Space Invaders without any change. In this case, the network learns to visually recognize and attend to the aliens. The ability to automatically learn representations of the world and extended sequential behaviors from only an objective function is a very attractive and exciting prospect.

Researchers have observed that small changes to these Atari games, can result in somewhat random behavior. For instance, deleting the ghosts from Pacman, which should make it easy for the agent to collect points without fearing attacks from ghosts results in an agent that wanders somewhat aimlessly suggesting that the system is not learning the same kinds of representations of the domain that a human does. For this reason, many researchers have been investigating ways of extracting explanations of agent behavior to understand if the agent's representations are likely to generalize.

Perturbation based saliency methods, originally developed for image classification networks, attempt to get at these representations by determining how changes to coherent regions of the input image change the agent's action choices. Information about what visual features are being used can be helpful when trying to determine if the appropriate visual features are being represented. Saliency features, however, are not useful when trying to reason about why the agent chooses one action or another in a given situation. Researchers have attempted to uncover the structure of agent behavior by clustering latent state embeddings created by the networks, finding transitions between these clusters and then using techniques from finite automata theory to minimize these state machines to make them more interpretable. These methods may rely on humans to supply semantic interpretations of the states based on watching agent's behavior and trying to puzzle out how it relates to the abstract integer state of the finite automata. It is also unclear how interpretable these will be if the state machine becomes at all complex (which is likely as integer state machines do not factorize environment state resulting in combinatorial complexity as domain state variables interact). They also fail to shed light on how a particular action choice relates to the agent's goals.

One approach exploits semantics of the reward function structure. The human engineer architects the reward function for a problem to explicitly relate features of the state, such as the successful kill of an alien in the game, to a reward value used to optimize the agent's policy. In many domains, this reward function can have rich structure. An agent might be trying to avoid being killed while simultaneously trying to minimize travel time, minimize artillery use, capture territory, and maximize the number of killed opponents. These terms may appear separately in the reward function. Researchers have exploited this structure to make behavior more interpretable. They observe that the linearity of the Q-function (which represents the expected future value of taking an action in a state) allows it to be decomposed. The Bellman function defines how the value of an action in a state is equal to the immediate reward R(s,a), plus the reward of states the agent might get to in the future as shown in (1).

$$Q ( s , a ) = R ( s , a ) + γ {\sum }_{{s}^{′}} P r ( {s}^{′} \vert s , a ) {max}_{{a}^{′}} Q ( {s}^{′} {a}^{′} ) \qquad ( 1 )$$

If the reward can be decomposed into terms for each concern of the agent (death, travel, bullets, etc), the Q function can be expressed in terms of this decomposition as shown in (2).

$$Q ( s , a ) = {R}_{death} ( s , a ) + {R}_{travel} ( s , a ) + {R}_{bullets} ( s , a ) + … + γ {\sum }_{{s}^{′}} P r ( {s}^{′} \vert s , a ) {max}_{{a}^{′}} Q ( {s}^{′} {a}^{′} ) \qquad ( 2 )$$

Because Q-values are a linear function of rewards, the Q-function itself can be decomposed. The expected value can be computed with respect to a single concern as shown in (3).

$${Q}_{death} ( s , a ) = {R}_{death} ( s , a ) + γ {\sum }_{{s}^{′}} P r ( {s}^{′} \vert s , a ) {max}_{{a}^{′}} {Q}_{death} ( {s}^{′} {a}^{′} ) \qquad ( 3 )$$

The total Q-value of an action in a state can then be expressed as the sum of concern specific Q functions as shown in (4).

Q(s,a)=Q_{death}(s,a)+Qₜᵣₐᵥₑₗ(s,a)+Q_{bullets}(s,a)+ . . . (4)

This allows an understanding of the value of a local atomic action in terms of its contribution to future reward associated with specific concerns. So an action might dominate at time t because it reduces travel or avoids death. At a high-level the idea is to find the minimal set of positive rewards for an action that dominate the negative rewards of alternative actions and use this as an explanation.

One of the challenges of applying this to high dimensional visual inputs is that it is already difficult and time consuming to train the networks using the diffuse signal provided by sparse rewards. Adding a large number of additional separate networks that each have their own errors and variances that will be added together will make it much harder to optimize. Second, in continuous action domains it is difficult to use Q-learning as one would have to maximize a non-linear Q-function to obtain actions and define distributions over actions for exploration. Policy gradient methods, which do not compute Q-values are therefore widely used in these contexts. For both of these reasons, this technique has not seen wide application to practical problems. This is unfortunate as the only explicit semantic grounding present in the deep RL framework is the human engineered reward function.

Embodiments describe herein use the benefits of factored rewards for explanation while maintaining good convergence and being able to use policy gradients. This can be done by separating the learning and explanation functions while still retaining faithfulness of representation. This allows use of state-of-the art learning algorithms while getting good convergence and still being able to get insight into why the agent does what it does. Embodiments described herein can be used to implement this concept for a policy gradient algorithm which is the basis of many modern deep RL learners such as AC3 and proximal policy optimization (PPO).

In policy gradient algorithms, a network is used, traditionally described by π_{θ}(a|s), to assign a value to various actions. Gradient descent is used to tune the parameters of this network to maximize the expected return ∇_{θ}J(θ). The policy gradient algorithms rely on the policy gradient theorem which allows the computation of the gradient of return without needing to take the derivative of the stationary distribution d^{π}(s) and replacing an explicit expectation with samples drawn from the environment under the policy in question E_{π}. The gradient ∇_{θ}J(θ) can then be used to update the policy network to maximize reward.

$${∇}_{θ} J ( θ ) ∝ {\sum }_{s ∈ S} {d}^{π} ( s ) {\sum }_{a ∈ A} {Q}^{π} ( s , a ) {∇}_{θ} {π}_{θ} ( a \vert s ) = {\sum }_{s ∈ S} {d}^{π} ( s ) {\sum }_{a ∈ A} {π}_{θ} ( a \vert s ) {Q}^{π} ( s , a ) \frac{{∇}_{θ} {π}_{θ} ( a \vert s )}{{π}_{θ} ( a \vert s )} = {E}_{π} [ {Q}^{π} ( s , a ) {∇}_{θ} ln {π}_{θ} ( a \vert s ) ] ; \\ Because {( ln x )}^{′} = 1 / x \qquad ( 5 )$$

In deep policy networks, this is implemented by passing images through convolutional neural networks to create latent features and then using a fully connected network, or perhaps two layers followed by a softmax layer to calculate policy probabilities.

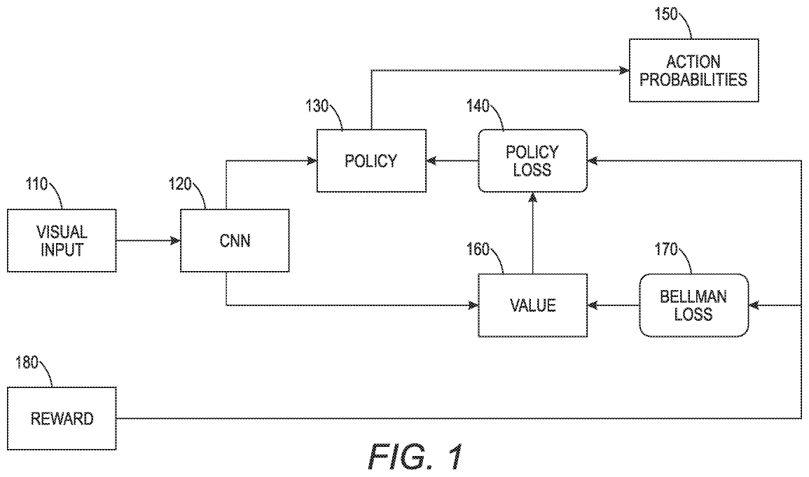

Unfortunately, a textbook implementation may be unstable. Modern methods typically use an estimate of the value of states as a baseline in the action value calculation. The state value estimate function 160 is the maximum action value at each state (V_{θ}(s)=maxₐV_{θ}(s, a)). The bias term in the policy loss 140 used to optimize the policy 130 can be updated using standard Bellman loss 170. The overall flow is captured in FIG. 1.

As shown in FIG. 1, visual input is received 110. The visual input may be in the form of video, for example. The video may be received at a convolutional neural net (CNN) 120. The CNN 120 may be used to high level descriptive features to a policy function 130 which has been tuned to produce action probabilities 150 that maximize the cumulative reward function 180.

While the theory behind policy gradient is concise and elegant, getting deep network-based reinforcement learning agents to converge in practice requires a number of tricks and patience to tune many hyperparameters. A single training episode can take days or weeks. It therefore may be undesirable to increase the complexity of the network by adding additional structure. Early on, adding extra network outputs can create noise when updating the core CNN representation that makes learning harder.

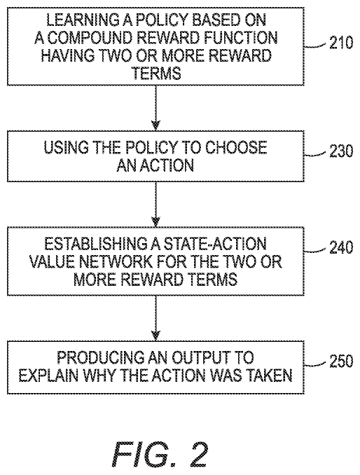

FIG. 2 shows a process for determining why an action was taken in accordance with embodiments described herein. A policy based on a compound reward function is learned 210 via a reinforcement learning algorithm at a learning network. The policy is used 220 to choose an action of a plurality of possible actions. A state-action value network is established 230 for each of the two or more reward terms. According to various embodiments, the state-action value networks are separated from the learning network. A human-understandable output is produced 240 to explain why the action was taken based on each of the state action value networks.

Using embodiments described herein, the agent is trained using the base version of the policy gradient algorithm or one of its many derivatives (e.g., AC3) to get an optimal policy π_{θ*}. This creates a policy 330 that the agent can follow to maximize the reward sum 350. The Q-value 360 is averaged over the episodes. Similarly to FIG. 1, the bias term in the policy loss 340 can be updated using standard Bellman loss 370.

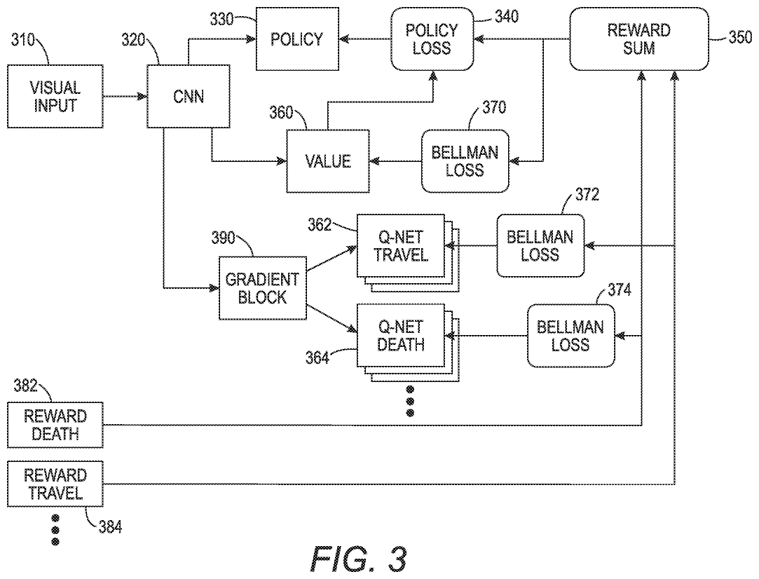

In FIG. 3, a Q-value or state-action value network is introduced for each possible term in the reward function (e.g., Q_{death}(s,a) 364, Qₜᵣₐᵥₑₗ(s,a) 362, etc.) The networks 362, 364 are connected to the latent representation generated by CNNs through a gradient blocking node 390 which passes forward activation but blocks backward gradients. Now, the optimal policy π_{θ*}. 330 can be run to generate samples (s,a,r,s′). The samples can be used with a Bellman error based loss 372, 374 for each of the reward terms and the factorized rewards 382, 384 to train the Q-functions 362, 364 to generate the factorized Q-values 362, 364. According to various embodiments, each one of these Q functions 362, 364 is trained only on the Bellman loss 372, 374 with respect to one factor of the reward function.

$$B {E}_{death} = [ {R}_{death} ( s , a ) + γ {\sum }_{{s}^{′}} P r ( {s}^{′} \vert s , a ) {max}_{{a}^{′}} Q ( {s}^{′} {a}^{′} ) ] - {Q}_{death} ( s , a ) \qquad ( 6 )$$

(7) illustrates the effect of substituting samples drawn from the environment for the expectation over transitions and using learning rate α.

$${Q}_{death} ( s , a ) = {Q}_{death} ( s , a ) + α [ [ {R}_{death} ( s , a ) + γ {max}_{{a}^{′}} {Q}_{death} ( {s}^{′} , {a}^{′} ) ] - {Q}_{death} ( s , a ) ] \qquad ( 7 )$$

These factorized Q-values can then be used to explain the long-term contribution of any local action to the agent's overall goals as defined by the reward function. These extra networks may be referred to herein as an auxiliary factored Q function. The gradient blocking node prevents training of the auxiliary network from affecting the underlying policy network preserving optimality and stability. The coupling of the Q-network to the base implementation feature generation CNNs aligns the representation used for calculating Q-values with that used for calculating policy probabilities leading to increased levels of faithfulness and likely better generalization.

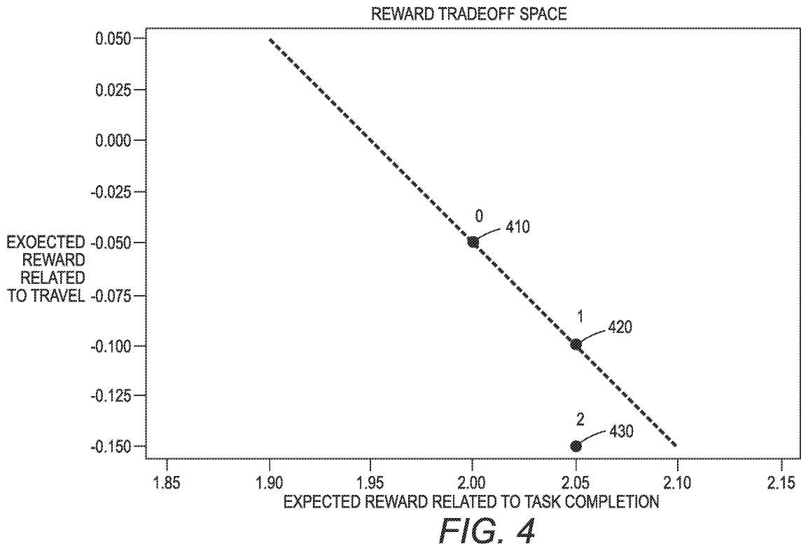

According to embodiments described herein, it may be useful to explicitly plot actions values in a tradeoff space as shown in FIG. 4. The horizontal axis represents expected reward received due to completion of task. The vertical axis represents expected penalty due to travel distance. Because rewards enter into the final summation as independent terms without coefficients, lines of equal reward will be defined by 45 degree lines for pairs of values (or more generally hyperplanes for N values) in the reward space. Here we can see that actions 0 410 and 1 420 lie on an iso reward line and have equal expected reward return: action 1 420 increases the penalty due to travel distance, but also increases the task completion probability and therefore the expected reward by a commensurate amount. In contrast, action 2 430 also increases the travel penalty, but fails to increase the completion reward enough to compensate so it is dominated by actions 0 410 and 1 420. This may be used to establish a threshold that can be used by users to screen out actions that have nearly equal value in one or more dimensions and make the remaining dimensions available for two-dimensional tradeoff visualizations.

Using embodiments described herein, the agent is trained using the base version of the policy gradient algorithm or one of its many derivatives (e.g., AC3) to get an optimal policy π_{θ*} based on visual input 310 received at a CNN 320. The output of the CNN provides high level features to a policy network 330 that the agent can follow to maximize the reward sum 350. The Q-value 360 is averaged over the episodes. Similarly to FIG. 1, the bias term in policy loss computation 340 can be updated using standard Bellman loss 370.

In FIG. 3, a Q-value or state-action value network is introduced for each possible term in the reward function (Q_{death}(s,a) 364, Qₜᵣₐᵥₑₗ(s,a) 362, etc.) The networks 362, 364 are connected to the latent representation generated by CNNs through a gradient blocking node 390 which passes forward activation but blocks backward gradients. Now, the optimal policy π_{θ*} 330 can be run to generate samples (s,a,r,s′). The samples can be used with a Bellman error based loss 372, 374 and the factorized rewards 382, 384 to train the Q-functions 362, 364 to generate the factorized Q-values 362, 364. According to various embodiments, each one of these Q functions 362, 364 is trained only on the Bellman loss 372, 374 with respect to one factor of the reward function.

According to embodiments described herein, one can use the value node from the original policy gradient algorithm to provide a bootstrap estimate of the auxiliary Q-value functions during updates. This should accelerate convergence of the auxiliary networks compared to using an independent update as shown in (8).

Q_{death}(s,a)=Q_{death}(s,a)−α[[R_{death}(s,a)+γV_{policy_network}(s′)]−Q_{death}(s,a)] (8)

According to various embodiments, one can alter the Q-networks so that they take both an action and a state as input ƒ(s,a) to allow for continuous actions. These may be more difficult to optimize as gradient ascent may be used to find an action that obtains the local maximum in value. In some embodiments, the policy learning and auxiliary explanation learning can be run at the same time. Due to the gradient blocking node, training of the Q-value functions will not affect learning or convergence of the agent. This could be useful in debugging the learning of the agent before it is fully converged. One could understand what tradeoffs an agent is making and whether these are rational or not.

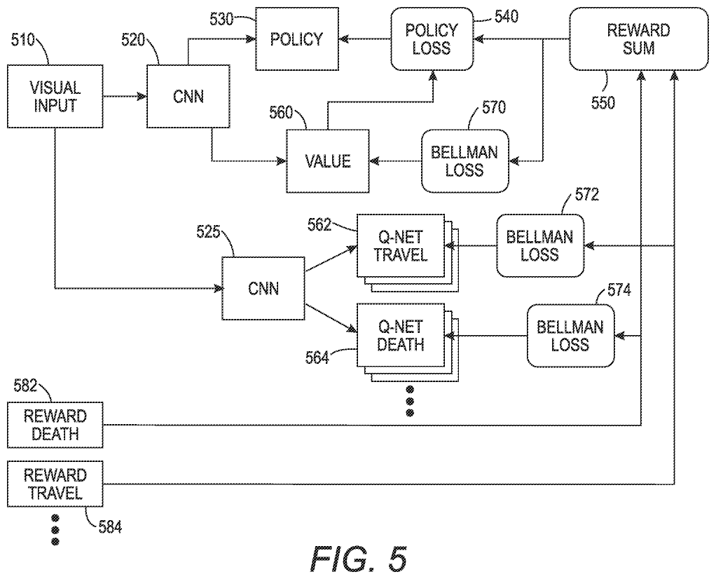

According to embodiments described herein, the explanation network might not share a representation with the underlying policy learner as shown in FIG. 5 This might be desirable if the implementation of the policy learner is not accessible. In this case, the explanation network may learn its own features which would likely reduce the faithfulness of the representation. The differences in representation could lead to differences in the way the policy network generalizes to new situations vs. the way that the explanation network generalizes to new situations.

In FIG. 5, first visual input 510 is received by a first CNN 520. The first CNN 520 is used to create a policy 530 that can be used to maximize the reward sum 550. The value function for states 560 is simply the expected value of possible actions at the state. The bias term in the policy loss 540 can be updated using standard Bellman loss 570. The visual input 510 may also be sent to a second CNN network 525 which provides an independent set of high-level features to the Q-functions representing expected rewards of specific terms in the reward function. There is no gradient block in this version, as the CNN is trained by backpropagation through the Q-functions.

Similarly to FIG. 3, a Q-value or state-action value network is introduced for each possible term in the reward function (Q_{death}(s,a) 564, Qₜᵣₐᵥₑₗ(a) 562, etc.) Now, the optimal policy π_{θ*} 530 can be run to generate samples (s,a,r,s′). The samples can be used with a Bellman error-based loss 572, 574 and the factorized rewards 582, 584 to train the Q-functions 562, 564 to generate the factorized Q-values 562, 564. According to various embodiments, each one of these Q functions 562, 564 is trained only on the Bellman loss 572, 574 with respect to one factor of the reward function.

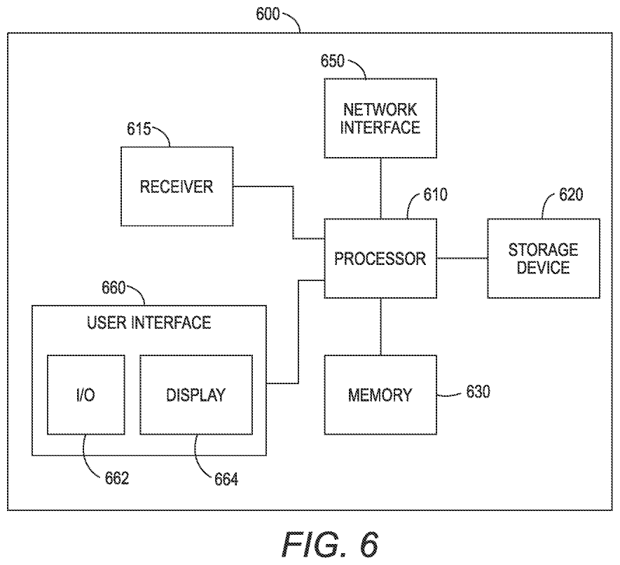

The above-described methods can be implemented on a computer using well-known computer processors, memory units, storage devices, computer software, and other components. A high-level block diagram of such a computer is illustrated in FIG. 6. Computer 600 contains a processor 610, which controls the overall operation of the computer 600 by executing computer program instructions which define such operation. It is to be understood that the processor 610 can include any type of device capable of executing instructions. For example, the processor 610 may include one or more of a central processing unit (CPU), a graphical processing unit (GPU), a field-programmable gate array (FPGA), and an application-specific integrated circuit (ASIC). The computer program instructions may be stored in a storage device 620 (e.g., magnetic disk) and loaded into memory 630 when execution of the computer program instructions is desired. Thus, the steps of the methods described herein may be defined by the computer program instructions stored in the memory 630 and controlled by the processor 710 executing the computer program instructions. The computer 600 may include one or more network interfaces 650 for communicating with other devices via a network. The computer 600 also includes a user interface 660 that enable user interaction with the computer 600. The user interface 660 may include I/O devices 662 (e.g., keyboard, mouse, speakers, buttons, etc.) to allow the user to interact with the computer. Such input/output devices 662 may be used in conjunction with a set of computer programs to receive visual input and display the human understandable output in accordance with embodiments described herein. The user interface also includes a display 664. The computer may also include a receiver 615 configured to receive visual input from the user interface 660 or from the storage device 620. According to various embodiments, FIG. 6 is a high-level representation of possible components of a computer for illustrative purposes and the computer may contain other components.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a computer-readable medium and transferred to the processor for execution as is known in the art.

The foregoing description of the example embodiments have been presented for the purposes of illustration and description. It is not intended to be exhaustive or to limit the inventive concepts to the precise form disclosed. Many modifications and variations are possible in light of the above teachings. Any or all features of the disclosed embodiments can be applied individually or in any combination, not meant to be limiting but purely illustrative. It is intended that the scope be limited by the claims appended herein and not with the detailed description.

What is claimed is:

1. A method for providing human understandable explanations for an action in a machine reinforcement learning framework comprising:
learning, through a reinforcement learning algorithm at a learning network, a policy based on a compound reward function, the compound reward function comprising a sum of two or more reward terms;
using the policy to choose an action of a plurality of possible actions;
establishing a state-action value network for each of the two or more reward terms, the state-action value networks separated from the learning network; and
producing a human-understandable output to explain why the action was taken based on each of the state action value networks.

2. The method of claim 1, wherein producing a human-understandable output comprises producing a reward tradeoff space that plots the plurality of possible actions based on the two or more reward terms.

3. The method of claim 2, wherein producing a reward tradeoff space comprises plotting possible actions with substantially equal reward based on the compound reward function on the same line.

4. The method of claim 3, further comprising screening out possible actions that have substantially equal reward.

5. The method of claim 2, further comprising screening out possible actions that have substantially similar reward based on a similarity threshold.

6. The method of claim 5, wherein the similarity threshold is a predetermined value.

7. The method of claim 5, wherein the similarity threshold is specified by a user.

8. The method of claim 5, wherein the similarity threshold is based on a number of possible actions.

9. The method of claim 1, wherein the state action value networks share a latent embedding representation with the learning network.

10. The method of claim 1, wherein the state action value networks are separated from the latent embedding representation of the learning network through a gradient blocking node.

11. The method of claim 1, wherein learning through the learning network and learning through the state action value networks are done at substantially the same time.

12. The method of claim 1, wherein the policy is configured to maximize an output of the compound reward function.

13. The method of claim 1, wherein each of the state action value networks are trained on a Bellman loss based on the respective reward term.

14. The method of claim 1 where instead of using the representation of the reinforcement learner to calculate Q-values for specific terms in the reward function, there is a separate visual pipeline for the auxiliary explanation terms.

15. A system comprising:
a processor; and
a memory storing computer program instructions which when executed by the processor cause the processor to perform operations comprising:
learning, through a reinforcement learning algorithm at a learning network, a policy based on a compound reward function, the compound reward function comprising a sum of two or more reward terms;
using the policy to choose an action of a plurality of possible actions;
establishing a state-action value network for each of the two or more reward terms, the state-action value networks separated from the learning network; and
producing a human-understandable output to explain why the action was taken based on each of the state action value networks.

16. The system of claim 15, wherein producing a human-understandable output comprises producing a reward tradeoff space that plots the plurality of possible actions based on the two or more reward terms.

17. The system of claim 16, wherein producing a reward tradeoff space comprises plotting possible actions with substantially equal reward based on the compound reward function on the same line.

18. The system of claim 17, further comprising screening out possible actions that have substantially equal reward.

19. The system of claim 16, further comprising screening out possible actions that have substantially similar reward based on a similarity threshold.

20. The method of claim 15, wherein the state action value networks share a latent embedding representation with the learning network.
